(19) United States
(12) Patent Application Publication
(10) Pub. No.: US 2010/0257034 A1
(43) Pub. Date: Oct. 7, 2010

(54) OPTICAL DISK DRIVE AND ADVERTISEMENT AND SERVICE SYSTEM USING THE SAME

(76) Inventors: In Chang Yang, Seoul (KR); Man Hyng Lee, Seoul (KR); Sun Ho Lee, Seoul (KR); Byung Hoon Min, Seoul (KR)

Correspondence Address: BIRCH STEWART KOLASCH & BIRCH, PO BOX 747, FALLS CHURCH, VA, 22040-0747, US

(21) Appl. No.: 12/741,292

(22) PCT Filed: Jan. 21, 2008
(86) PCT No.: PCT/KR2008/000361

§ 371 Date: May 4, 2010

(30) Foreign Application Priority Data
Nov. 5, 2007 (KR) 10-2007-0111861

(51) Int. Cl. G06Q 30/00; G11B 20/10

(52) U.S. Cl. 705/14.4; 705/26; 369/47.36; G9B/20.009

(57) ABSTRACT

Provided are an optical disk drive and an advertisement/service system using the same. The optical disk drive includes an optical disk storage unit, an Internet link storage unit, and a controller. The optical disk storage unit stores or reproduces contents using an optical disk. The Internet link storage unit stores an Internet link in an inside and is executed as a virtual optical disk when the optical disk is not presentpresentontroller controls the optical disk storage unit and the Internet link storage unit, and controlling an access to be made, subject to the Internet link storage unit. The service system using the optical disk drive includes a user terminal, an optical disk service network, and a network connecting the user terminal and the optical disk service network. The user terminal includes an optical disk drive configured to allow an Internet link. The optical disk service network is connected via the Internet link included in the user terminal and receives an optical disk service request from a user. The advertisement system using the optical disk drive includes a user terminal, an advertisement server, and a network connecting the user terminal and the advertisement server. The user terminal includes an optical disk drive so configured as to allow an advertisement link. The advertisement server is connected via the advertisement link included in the user terminal and provides service to a user.

### TECHNICAL FIELD

The present disclosure relates to an optical disk drive having a separate memory virtualized as an optical disk to allow an Internet link, and an advertisement and service system using the same.

### BACKGROUND ART

As demands for processing high-quality moving images increase, a high-capacity data storage optical disk is required. Consequently, high-density rewritable optical recording medium that can record and store high quality video and audio data for many hours is brought to the market, recently.

Examples of the high-density rewritable optical recording medium include a blue lay disk (BD), a high definition digital versatile disk (HD-DVD), etc. The DVD has an about 4.7 GB recording capacity and the BD has an about 25 GB recording capacity. After the BD standard has been introduced, the next generation high density/ultra miniature optical storage device has been developed. Examples of the next generation high density/ultra miniature optical storage device include technologies such as a super-lens, holography, near field recording, etc.

Recently, because these optical storage devices (e.g., compact disk (CD), DVD, BD, HD-DVD) are widely distributed, a home or office of company keeps several tens to hundreds of optical storage disks containing various contents.

FIG. 1 is a block diagram of a structure of a related art optical disk drive.

The related art optical disk drive includes an optical disk 21, a pick-up unit 11, a servo unit 12, a signal processing unit 14, a memory 15, and a micom 13. The optical disk 21 is a recording medium on which data are recorded, reproduced, and erased by a laser. The pick-up unit 11 records/reproduces management information including data recorded on the optical disk 21. The servo unit 12 controls operations of the pick-up unit 11. The signal processing unit 14 demodulates a reproduction signal received from the pick-up unit 11 into a desired signal value, or modulates a signal to be recorded into a signal having a form necessary for performing a recording operation on the optical disk 21 to transmit the signal. The memory 15 stores various information necessary for reproducing the optical disk 21. The micom 13 controls operations of the above components. The components form a recording/reproducing unit 10.

The pick-up unit 11 includes a laser light source such as a laser diode, a collimator lens, an objective lens driven by a focus actuator or a tracking actuator, a polarized beam splitter, an optical component such as a cylindrical lens, a photodetector converting light into an electrical signal, and a front monitor diode monitoring a laser output during a recording or reproducing operation.

The micom 13 detects reflected light from the optical disk 21, and calculates an amount of the reflected light through the detected reflected light to generate a radio frequency (RF) signal representing a total sum of the reflected light with respect to each area of photodiodes. Additionally, the micom 13 generates a focus error signal FE, which is a signal detecting an out-of-focus laser illuminated by the pick-up unit 11 through an astigmatism method. Additionally, the micom 13 generates a tracking error signal TE detecting an out-of-track laser illuminated by the pick-up unit 11 through a push-pull method.

The memory 15 stores various information necessary for reproducing the optical disk 21 and typically includes a random access memory (RAM) and a read only memory (ROM) to store a control program, a theoretical length of each pit and land, or existence probability in combination of each pit and land.

A controller 23 is responsible for controlling entire components.

A decoder 22 finally decodes output data in response to control of the controller 23 and then provides the decoded data to a user.

To record user desired data on a recoding medium, an encoder 24 converts an input signal into a signal of a predetermined format, e.g., a motion picture experts group 2 (MPEG2) transport stream, and then provides the converted signal to the signal processing unit 14 in response to control of the controller 23.

As described above, FIG. 1 illustrates components of recording and reproducing units of the related art optical disk drive. In relation to the reproducing of the optical disk, the optical disk 21, the recording/reproducing unit 10, and the decoder 22 are used. In relation to the recording of the optical disk, the recoding/reproducing unit 10, and the decoder 22 are used in response to control of the controller 23.

Since the optical disk drive reproduces/executes only the contents stored on the optical disk 21, there is inconvenience that the optical disk 21 should be replaced with a new optical disk when a user intends to execute other contents.

Also, since the Internet cannot be connected using a related art optical disk drive, inconvenience has been generated to a user.

Also, in case of purchasing an optical disk or receiving additional service such as labeling, there is no sufficient guidance and a user has had an inconvenience of having to find out a purchase site.

Accordingly, a using pattern and a service pattern of an optical disk change as the Internet develops, and a new type of service providing method is highly required.

### DISCLOSURE OF INVENTION

### Technical Problem

Embodiments provide an optical disk drive and an advertisement and service system using the same that allow various service and advertisement effects through an Internet link by providing a virtual disk to a user even when an optical disk is not present in the optical disk drive.

Embodiments also provide an optical disk drive and an advertisement and service system using the same that can provide connection to various services to a user by providing a separate memory in which an Internet link is stored to the optical disk drive, and emulating the memory as an optical disk.

### Technical Solution

To solve related art limitations, a separate memory device in which an Internet link has been stored is provided to an optical disk drive, and the memory device is emulated as an optical disk, so that connection to various services can be provided to a user.

The present disclosure relates to an optical disk drive having a separate memory virtualized as an optical disk to allow an Internet link, and an advertisement and service system using the same.

In one embodiment, an optical disk drive includes: an optical disk storage unit storing or reproducing contents using an optical disk; an Internet link storage unit storing an Internet link in an inside and executed as a virtual optical disk when the optical disk is not present; and a controller controlling the optical disk storage unit and the Internet link storage unit, and controlling an access to be made, subject to the Internet link storage unit.

The controller may include an optical disk management unit controlling the optical disk storage unit and performing an optical disk processing command of a host to return a result to the host; an Internet link management unit copying a file system of the optical disk to apply the file system to the Internet link storage unit so that the Internet link storage unit is executed as a virtual optical disk, and controlling connection to be made to a link stored in the Internet link storage unit; and an optical disk judgment unit judging whether an optical disk is present when the optical disk processing command of the host is present.

The Internet link management unit may copy the file system of the optical disk to apply the file system to the Internet link storage unit, perform the optical disk processing command from the host using an optical disk processing instruction, and return one of a result and a state to the host in response to the command from the host.

The optical disk processing instruction may include an advanced technology attachment packet interface. The Internet link storage unit may perform a recording operation in the same data form as that of the optical disk. When the Internet link stored in the Internet link storage unit is executed and a corresponding site is connected, hardware information of an entire system (or optical disk drive) on a user side may be transmitted to the site.

In another embodiment, an optical disk service system includes: a user terminal including an optical disk drive configured to allow an Internet link; an optical disk service network connected via the Internet link included in the user terminal and receiving an optical disk service request from a user; and a network connecting the user terminal and the optical disk service network.

The optical disk service network may include: a user management server managing information of a user requesting service from the optical disk service network; a database storing service contents requested by the user and service processing results; and a delivery management server providing delivery data to a deliverer so that the deliverer performs a delivery operation corresponding to the user requested service.

The optical disk drive may include an Internet link storage unit, and the Internet link storage unit is emulated as a virtual optical disk when an optical disk is not present in the optical disk drive. Hardware information of an entire system (or optical disk drive) on a user side may be transmitted to the optical disk service network when the user terminal is connected to the optical disk service network.

In further another embodiment, an advertisement system using an optical disk drive includes: a user terminal including an optical disk drive configured to allow an advertisement link; an advertisement server connected via the advertisement link included in the user terminal and providing service to a user; and a network connecting the user terminal and the advertisement server.

The optical disk drive may include an advertisement link storage unit, and the advertisement link storage unit is emulated as a virtual optical disk when an optical disk is not present in the optical disk drive. The advertisement link is updated when the number of times of connection to the advertisement server exceeds a predetermined number of times.

The details of one or more embodiments are set forth in the accompanying drawings and the description below. Other features will be apparent from the description and drawings, and from the claims.

### ADVANTAGEOUS EFFECTS

According to the present disclosure, a user can use a virtual optical disk even when an optical disk is not present in an optical disk drive, and the virtual optical disk provides the same physical characteristic that that of a real physical optical disk, so that user convenience can improve.

Also, since the virtual optical disk performs the same operation as that of a real physical optical disk, the virtual optical disk in a disk drive can be read by any device regardless of an operating system (OS).

Also, since an optical disk is realized in the form of a virtual optical disk, there is no limit in size, access speed, and no limitation such as recognition time of a physical disk.

Also, since a semi-forcible advertisement effect is provided through a virtual optical disk, profit creation as a new profit business can be expected.

### BRIEF DESCRIPTION OF THE DRAWINGS

FIG. 1 is a block diagram illustrating the construction of a general optical disk drive.

FIG. 2 is a block diagram illustrating the construction of an optical disk drive according to an embodiment.

FIG. 3 is a flowchart of an optical disk emulation process according to an embodiment.

FIG. 4 is a block diagram of an optical disk service system according to an embodiment.

FIG. 5 is a schematic flowchart of an optical disk service providing sequence according to an embodiment.

FIG. 6 is a block diagram of an advertisement system using an optical disk drive according to an embodiment.

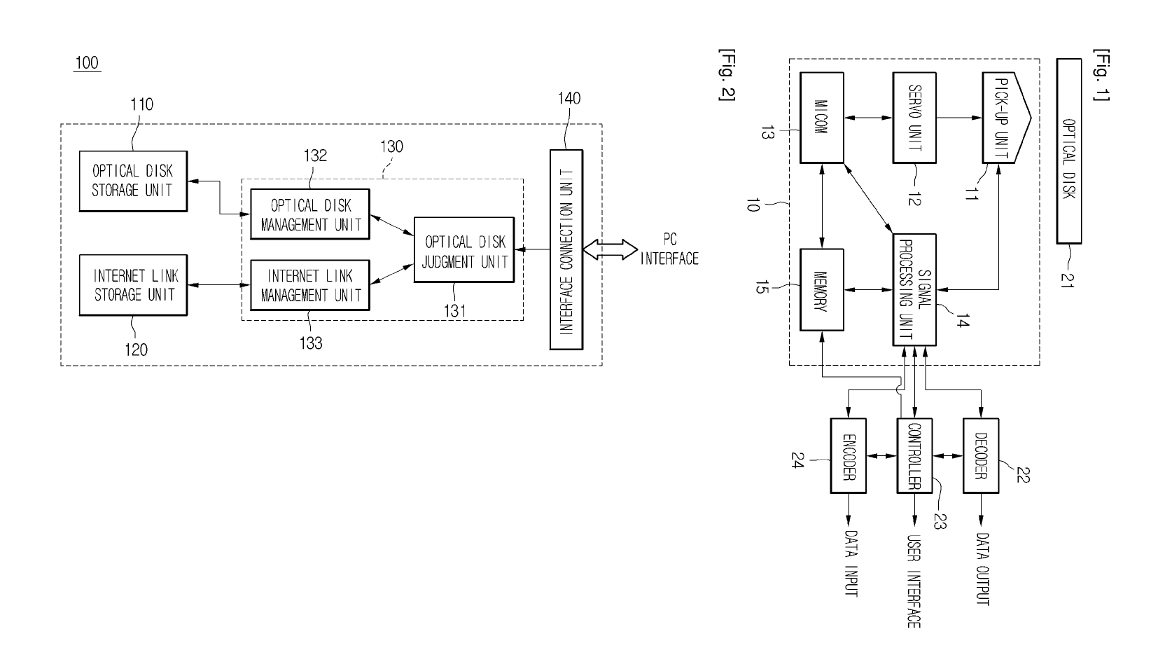

### BEST MODE FOR CARRYING OUT THE INVENTION

Reference will now be made in detail to the embodiments of the present disclosure, examples of which are illustrated in the accompanying drawings.

FIG. 2 is a block diagram illustrating the construction of an optical disk drive according to an embodiment.

The optical disk drive 100 includes: an optical disk storage unit 110 storing or re-producing contents using an optical disk; an Internet link storage unit 120 storing an Internet link in an inside and executed as a virtual optical disk when the optical disk is not present; and a controller 130 controlling the optical disk storage unit 110 and the Internet link storage unit 120, and controlling an access to be made, subject to the Internet link storage unit 120.

The controller 130 can include an optical disk management unit 132 controlling the optical disk storage unit 110 and performing an optical disk processing command of a host to return a result to the host; an Internet link management unit 133 copying a file system of an optical disk to apply the file system to the Internet link storage unit so that the Internet link storage unit 120 is executed as a virtual optical disk, and controlling connection to be made to a link stored in the Internet link storage unit 120; and an optical disk judgment unit 131 judging whether an optical disk is present when an optical disk processing command of the host is present.

Also, the optical disk drive 100 can further include an interface connection unit 140 providing an interface path to the host.

The Internet link storage unit 120 can include a separate memory device, for example, a memory device such as a RAM and a ROM, or can include a spare space of an internal memory of the optical disk drive.

The Internet link storage unit 120 can store a shortcut connecting to an Internet link, and a hyper text markup language (HTML) file in which an Internet link list.

A user can access the optical disk drive 100 through a personal computer (PC) interface, and use the optical disk drive 100 through the interface connection unit 140.

When receiving a command from the host, the controller 130 controls the optical disk storage unit 110 or the Internet link storage unit 120.

More specifically, when an optical disk processing command from the host is received through the interface connection unit 140, the optical disk judgment unit 131 of the controller 130 judges whether an optical disk is present in the optical disk drive 100.

The optical disk judgment 131 can judge whether the optical disk is present using various methods. The various methods include a method of illuminating laser light and judging an optical disk is present when there is reflected light, and a method of rotating an optical disk and measuring a change in a rotation momentum to judge whether the optical disk is present.

When it is judged by the optical disk judgment unit 131 that the optical disk is not present in the optical disk drive 100, the Internet link management unit 133 controls the Internet link storage unit 120 to be executed as a virtual optical disk in response to a command from the host, and returns a result to the host.

A process of realizing the Internet link storage unit 120 as the virtual optical disk, that is, an emulation process is to give the attribute of an optical disk to the Internet link storage unit 120 to set the Internet link storage unit 120 such that the Internet link storage unit 120 operates as if it were an optical disk even when the optical disk is not present in the optical disk drive 100.

For performing emulation, the same file system managing optical disk files should be applied to the Internet link storage unit 120, and also the same instructions processing the optical disk should be used for the Internet link storage unit 120.

There are characteristics to be checked to emulate the Internet link storage unit 120 as the optical disk. Examples of the characteristics include a disk characteristic (whether a disk has a ROM type or R/RW type), a disk size, a disk details (tracks, session information, etc.), and read/write information.

To realize an optical disk drive having an Internet link according to an embodiment, a disk may have an inerasable disk type, i.e., a ROM type. With consideration of a purpose of emulating a memory device having an Internet link and semi-forcibly inducing a user to view an advertisement or link, a manufacturer or an advertisement producer may not permit the user to arbitrarily erase/modify a link connection.

The optical disk emulation is realized in a ROM type, the user cannot modify the contents of a disk as described above, a manufacturer and a company producing an optical disk drive can variably defined.

Also, the file system of the optical disk may be ISO9660, universal disk format (UDF), and UDF-bridge. The file system can be divided into a file system zone and a file data zone. A representative name of a disk, a disk size, and a pointer indicating a data position can be stored in the file system zone. When emulation of the Internet link storage unit 120 is performed as described above, the stored representative name of the disk is displayed by an operation manager to the user.

Therefore, easier Internet link can be provided to the user by setting the Internet link in the file system zone.

Also, for performing emulation of the memory as the optical disk, the same instructions processing the optical disk should be applied to the Internet link storage unit 120. The instructions can include advanced technology attachment packet interface (ATAPI).

The ATAPI allows the Internet link storage unit 120 to be emulated as a virtual optical disk using an instruction of Get Configuration, an instruction of Test Unit Ready, or an instruction of Read Capacity.

The instructions are exemplary for explaining the present disclosure and the present disclosure is not limited thereto.

Also, an operation of applying the file system to the Internet link storage unit 120 can be realized by directly copying file system information of the optical disk or compressing the file system depending on embodiments. The compression can be performed in various ways. For example, the file system can be copied using a small memory by not extracting the blocks of the file system zone filled with zero.

Also, depending on embodiments, management can be facilitated by compressing the file system through an update operation of position information using an address shift while not extracting blocks filled with zero, and consequently reducing a shift distance upon address mapping.

The optical disk drive 100 shown in FIG. 2 emulates the Internet link storage unit 120 to display the Internet link stored in advance. Accordingly, link information is semi-forcibly provided to the user, and an advertisement producer can obtain an indirect advertisement effect.

For example, when an optical disk is not present in an inside, a related art optical disk drive displays DVD/CD-RW drive (E:) to inform the user of a current empty state. The optical disk drive 100 according to an embodiment displays the Internet link stored in the Internet link storage unit 120. For example, the optical disk drive 100 displays LGE.com to advertise a specific enterprise, company, or goods, or provide an Internet link to a corresponding site.

When the Internet link stored in the Internet link storage unit 120 is executed and the corresponding site is connected, hardware information of the entire system (or optical disk drive) on a user side can be transmitted to the corresponding site. A process of judging whether to transmit the hardware information can be provided depending on embodiments.

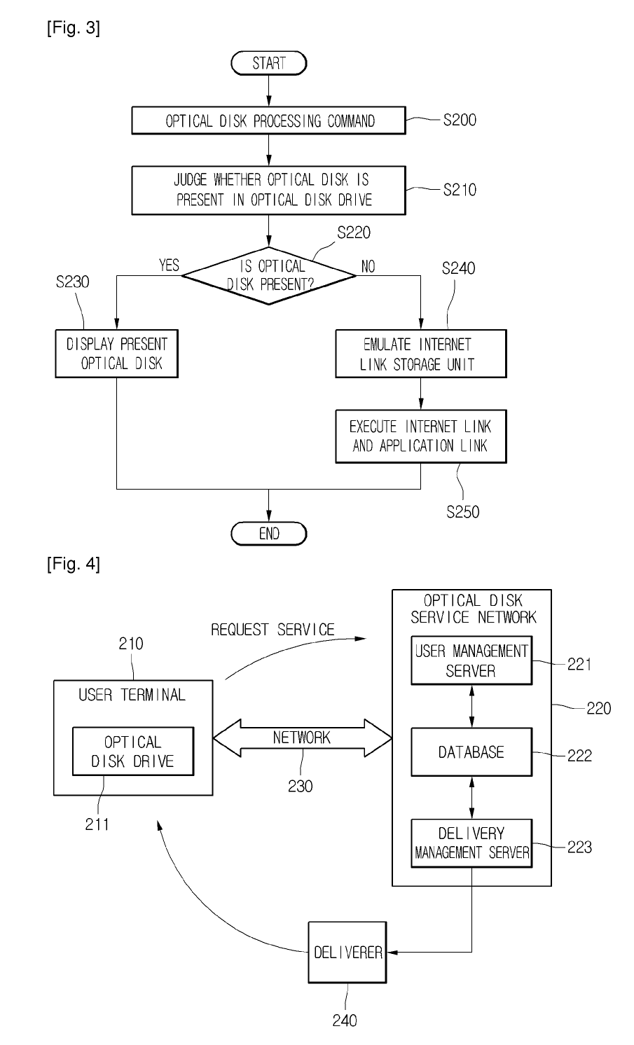

FIG. 3 is a flowchart of an optical disk emulation process according to an embodiment.

When an optical disk processing command from the host is present (S200), the optical disk judgment unit judges whether an optical disk is present in the optical disk drive (S210 and S220). When the optical disk is present in the optical disk drive as a result of the judgment, the optical disk is controlled by the optical disk management unit, and the present optical disk is displayed (S230).

When the optical disk is not present in the optical disk drive as a result of the judgment, the Internet link management unit emulates the Internet link storage unit according to an embodiment (S240). Next, an Internet link or application link stored in the Internet link storage unit is executed (S250).

At this point, whether to automatically execute the Internet link can be set. In the case where the automatic execution is set to be made, an automatic execution link file (e.g., autorun.exe) on the virtual disk is called to execute the Internet link or application link.

On the other hand, in the case where the automatic execution is set not to be made, a file list is displayed and Internet connection information or an application can be selected and executed. Otherwise, whether to perform an update operation or other operation can be performed.

FIG. 4 is a block diagram of an optical disk service system according to an embodiment.

The optical disk service system includes: a user terminal 210 including an optical disk drive 211 configured to allow an Internet link; an optical disk service network 220 connected via the Internet link included in the user terminal 210 and receiving an optical disk service request from a user; and a network 230 connecting the user terminal 210 and the optical disk service network 220.

The optical disk service can include disk purchase service, disk burning service, and disk labeling service and is not limited thereto but can be applied to similar service dealing with an optical disk.

A user using the user terminal 210 having the optical disk drive 211 according to an embodiment can access the optical disk service network 220 including a purchase site where the user desires to receive the optical disk service on the network 230 via the Internet link through emulation.

The optical disk service network 220 can include: a user management server 221 managing information of a user requesting service from the optical disk service network 220; a database 222 storing service contents requested by the user and service processing results; and a delivery management server 223 providing delivery data to a deliverer so that the deliverer performs a delivery operation corresponding to the user requested service.

The user management server 221 manages information of users making an access to the optical disk service network 220. For example, the user management server 221 manages personal data, addresses, and access histories of the users making an access using the user terminal 210.

Also, when the user of the user terminal 210 accesses the optical disk service network 220, hardware information of the entire system (optical disk drive) on the user side is transmitted to the optical disk service network 220, so that the user management server 221 can control the above operation.

The database 222, which is designed for storing various information for performing the optical disk service, can store service contents requested by the user and corresponding service processing results.

After the user is identified by the user management server 221, the delivery management server 223 provides delivery data to a deliverer 240 (delivery company) so that the deliverer can perform a delivery operation corresponding to requested service on the basis of service contents stored in the database 222. That is, a service provider operating the optical disk service provides requested goods/service to the user. At this point, the delivery management server 223 can allow an operator of the optical disk service network 220 to provide delivery path information regarding service-requested goods to a consumer using short message service (SMS) and electronic (e) mail.

Also, the optical disk service network can further include a payment server making payment of a fee for user requested service. The payment server confirms a user through user authentication and makes payment of a fee for the service contents in cooperation with a financial organization such as a bank.

The user can access the optical disk service network 220 to request various services associated to an optical disk. For example, the user can request services such as disk purchase, disk burning, and disk labeling.

When the user inputs the kinds and number of optical disks upon the disk purchase request, a corresponding service is completed and the user can conveniently receive the optical disks at home or his office from the deliverer 240.

The user can additionally upload data to be used for the disk burning upon the disk burning request. The operator of the optical disk service network 220 performs the data burning service using the data and delivers the disk to the user.

Also, the user can request the disk labeling service. When the user uploads/selects a label figure or phrase, the operator of the optical disk service network 220 performs the disk labeling service and delivers the disk to the user in response to the request from the user.

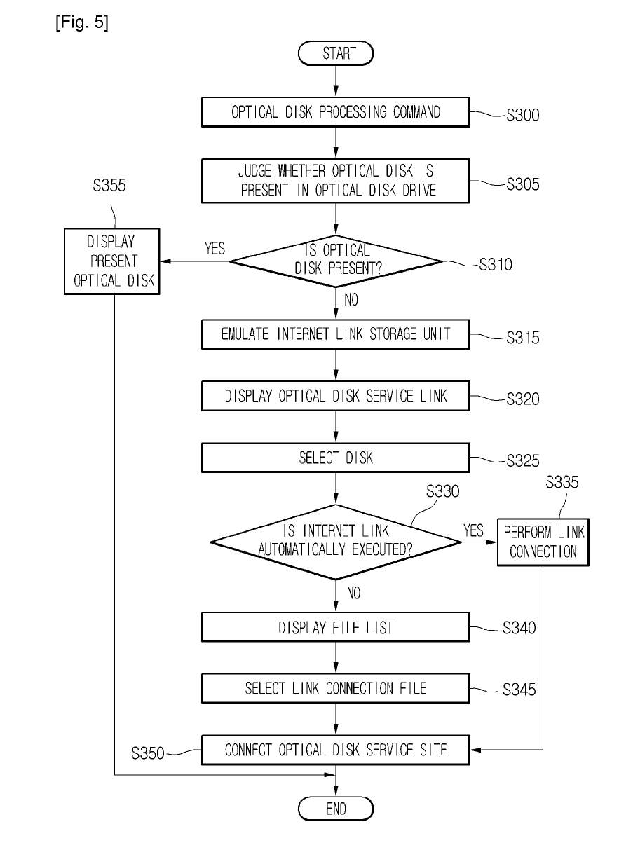

FIG. 5 is a schematic flowchart of a sequence according to which a user receives optical disk service in an embodiment.

When an optical disk processing command from the host is present (S300), the optical disk judgment unit judges whether an optical disk is present in the optical disk drive (S305 and S310).

When the optical disk is not present as a result of the judgment, an emulation process according to an embodiment is performed. That is, emulation is so performed as to recognize the Internet link provided to the optical disk drive as a virtual optical disk (S315), and the stored optical disk service link is displayed to the operation manager (S320).

When the optical disk is selected by the user (S325), whether to automatically execute the Internet link is judged. Whether to automatically execute the Internet link depends on an OS. A link connection is automatically executed (S335) and connection to an optical disk service site is made (S350) in an environment where automatic execution has been set. On the other hand, a stored file list is displayed first (S340) and when a link connection file is selected by the user (S345), connection to the optical disk service site is made (S350) in an environment the automatic execution has not been set.

In the case where an optical disk is present in the optical disk drive, the present optical disk application is displayed (S355).

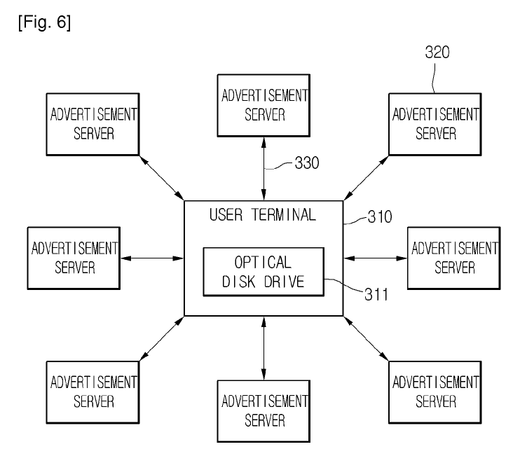

FIG. 6 is a block diagram of an advertisement system using an optical disk drive according to an embodiment. When the optical disk drive according to the embodiment is used, advertisements of various companies can be exposed and an advertisement effect can be given to the user using the optical disk drive.

Therefore, an advertisement system using the optical disk drive can be formed. The advertisement system includes: a user terminal 310 including an optical disk drive 311 so configured as to allow an advertisement link; an advertisement server 320 connected via an advertisement link included in the user terminal and providing service to a user; and a network 330 connecting the user terminal and the advertisement server.

The optical disk drive 311 includes an advertisement link storage unit so that it can be connected to a site of a specific company. The user can view a semi-forcible advertisement through the link, and directly access a corresponding site even without accessing a corresponding Internet site through input of uniform resource locator (URL).

In the optical disk drive according to an embodiment, an internal memory is emulated and an advertisement link stored in the memory can be displayed on an explorer. For example, eBay.com (E:) can be displayed. The user can select the displayed advertisement link to connect to a corresponding site.

The advertisement link can be set as a fixed type link or variable type link. In the case where the advertisement link is the fixed type link, an advertisement link of a specific company is permanently displayed by one-time contract between a product manufacturer and a specific company.

On the other hand, in the case where the advertisement link is the variable type link, the number of times of advertisement exposures through Internet link connection is set according to a contract condition between the product manufacturer and the specific company. When the number of times of advertisement exposures exceeds the number of times set upon the contract, an update operation to other advertisement link is performed.

The advertisement link can be updated in various ways. Examples of the updating of the advertisement link include a method of sequentially updating advertisement links stored upon manufacturing of the optical disk drive, and a method of updating the advertisement link by allowing a new advertisement provider to bid for the advertisement link when the number of times of the advertisement exposures of a specific company exceeds the contracted number of times. In this case, the advertisement system can further include a bid server (not shown) allowing the advertisement provider to bid for the advertisement link, select a new advertisement link, and replace the existing advertisement link with the selected advertisement link of the new advertisement provider.

Therefore, a manufacturing company of the optical disk drive can get profits through contracts with companies exposing an advertisement with various purposes, and sell an advertisement space. This can serve as a new advertisement exposure method, which can create a new market.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An optical disk drive comprising:
an optical disk storage unit storing or reproducing contents using an optical disk;
an Internet link storage unit storing an Internet link in an inside and executed as a virtual optical disk when the optical disk is not present; and
a controller controlling the optical disk storage unit and the Internet link storage unit, and controlling an access to be made, subject to the Internet link storage unit.

2. The optical disk drive according to claim 1, wherein the controller comprises:
an optical disk management unit controlling the optical disk storage unit and performing an optical disk processing command of a host to return a result to the host;
an Internet link management unit copying a file system of the optical disk to apply the file system to the Internet link storage unit so that the Internet link storage unit is executed as a virtual optical disk, and controlling connection to be made to a link stored in the Internet link storage unit; and
an optical disk judgment unit judging whether an optical disk is present when the optical disk processing command of the host is present.

3. The optical disk drive according to claim 2, wherein the Internet link management unit copies the file system of the optical disk to apply the file system to the Internet link storage unit, performs the optical disk processing command from the host using an optical disk processing instruction, and returns one of a result and a state to the host in response to the command from the host.

4. The optical disk drive according to claim 3, wherein the optical disk processing instruction comprises an advanced technology attachment packet interface.

5. The optical disk drive according to claim 1, wherein the Internet link storage unit performs a recording operation in the same data form as that of the optical disk.

6. The optical disk drive according to claim 1, wherein when the Internet link stored in the Internet link storage unit is executed and a corresponding site is connected, hardware information of an entire system on a user side is transmitted to the site.

7. An optical disk service system comprising:
a user terminal comprising an optical disk drive configured to allow an Internet link;
an optical disk service network connected via the Internet link included in the user terminal and receiving an optical disk service request from a user; and
a network connecting the user terminal and the optical disk service network.

8. The optical disk service system according to claim 7, wherein the optical disk drive comprises an Internet link storage unit, the Internet link storage unit being emulated as a virtual optical disk when an optical disk is not present in the optical disk drive.

9. The optical disk service system according to claim 7, wherein the optical disk service network comprises:
a user management server managing information of a user requesting service from the optical disk service network;
a database storing service contents requested by the user and service processing results; and
a delivery management server providing delivery data to a deliverer so that the deliverer performs a delivery operation corresponding to the user requested service.

10. The optical disk service system according to claim 7, wherein the optical disk service comprises disk purchase service, disk burning service, and disk labeling service.

11. The optical disk service system according to claim 7, wherein hardware information of an entire system on a user side is transmitted to the optical disk service network when the user terminal is connected to the optical disk service network.

12. An advertisement system using an optical disk drive, the advertisement system comprising:
a user terminal comprising an optical disk drive configured to allow an advertisement link;
an advertisement server connected via the advertisement link included in the user terminal and providing service to a user; and
a network connecting the user terminal and the advertisement server.

13. The advertisement system according to claim 12, wherein the optical disk drive comprises an advertisement link storage unit, the advertisement link storage unit being emulated as a virtual optical disk when an optical disk is not present in the optical disk drive.

14. The advertisement system according to claim 12, wherein the advertisement link is updated when the number of times of connections to the advertisement server exceeds a predetermined number of times.

15. The advertisement system according to claim 14, wherein the updating of the advertisement link comprises selecting one advertisement link on an advertisement link list stored in the optical disk drive and replacing the existing advertisement link with the selected advertisement link.

16. The advertisement system according to claim 14, wherein the updating of the advertisement link comprises allowing a new advertisement provider to bid for the advertisement link and replaying the advertisement link with an advertisement link of the new advertisement provider.

17. The advertisement system according to claim 16, further comprising a bid server allowing the advertisement provider to bid for the advertisement link, select a new advertisement link, and replace the existing advertisement link with the selected advertisement link.
